(19) United States
(12) Patent Application Publication
(10) Pub. No.: US 2023/0074533 A1
(43) Pub. Date: Mar. 9, 2023

(54) INFORMATION PROCESSING DEVICE, VEHICLE, AND STORAGE MEDIUM

(71) Applicant: TOYOTA JIDOSHA KABUSHIKI KAISHA, Aichi-ken (JP)

(72) Inventors: Mitsuhiro TABATA, Sunto-gun (JP); Motoki TAKAHASHI, Susono-shi (JP); Naofumi MAGARIDA, Sunto-gun (JP); Yuko AZUMA, Numazu-shi (JP); Takaharu TATEISHI, Nagoya-shi (JP)

(21) Appl. No.: 17/902,900

(22) Filed: Sep. 5, 2022

(30) Foreign Application Priority Data
Sep. 8, 2021 (JP) 2021-146444

(51) Int. Cl. B60L 1/00; B60W 50/10

(52) U.S. Cl. CPC B60L 1/003; B60W 50/10; B60W 2510/08; B60W 2510/305

(57) ABSTRACT

An information processing device includes a processor configured to select, when the processor acquires power supply request information requesting supply of electric power from a vehicle equipped with a power supply device that supplies electric power to outside to a power supply target to which a plurality of electronic devices is connected, the electronic device to which electric power is supplied from among the electronic devices based on the power supply request information.

### CROSS-REFERENCE TO RELATED APPLICATION

This application claims priority to Japanese Patent Application No. 2021-146444 filed on Sep. 8, 2021, incorporated herein by reference in its entirety.

### BACKGROUND

### 1. Technical Field

The present disclosure relates to an information processing device, a vehicle, and a storage medium.

### 2. Description of Related Art

Japanese Unexamined Patent Application Publication No. 2005-79957 (JP 2005-79957 A) discloses a technique for supplying electric power from a backup battery so as to extend the operating time of a security function.

### SUMMARY

When electric power is supplied from a vehicle to a power supply target such as a house, a plurality of electronic devices having different functions, such as various types of home appliances, is electrically connected to the electric line of the house. Therefore, there has been a demand for a technique for supplying electric power to the electronic devices in an appropriate manner when electric power is supplied from the vehicle to the power supply target such as a house.

The present disclosure has been made in view of the above, and it is an object of the present disclosure to provide an information processing device, a vehicle, and a storage medium capable of supplying electric power to, in an appropriate manner, a plurality of electronic devices that is electrically connected to a power supply target when electric power is supplied from the vehicle to the power supply target.

An information processing device according to the present disclosure includes a processor configured to select, when the processor acquires power supply request information requesting supply of electric power from a vehicle equipped with a power supply device that supplies electric power to outside to a power supply target to which a plurality of electronic devices is connected, the electronic device to which electric power is supplied from among the electronic devices based on the power supply request information.

A vehicle according to the present disclosure includes a power supply device that supplies electric power to outside; and a processor configured to select, when the processor acquires power supply request information requesting supply of electric power to a power supply target to which a plurality of electronic devices is connected, the electronic device to which electric power is supplied from among the electronic devices based on the power supply request information.

A non-transitory storage medium according to the present disclosure stores a program that causes a processor to select, when power supply request information requesting supply of electric power from a vehicle equipped with a power supply device that supplies electric power to outside to a power supply target to which a plurality of electronic devices is connected is acquired, the electronic device to which electric power is supplied from among the electronic devices based on the power supply request information.

According to the present disclosure, when electric power is supplied from the vehicle to the power supply target, electric power can be supplied to, in an appropriate manner, the electronic devices that are electrically connected to the power supply target.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a power supply system including an information processing device according to an embodiment;

FIG. 2 is a diagram schematically showing a state in which a vehicle and a target facility are connected by a connector;

FIG. 3 is a diagram showing a schematic configuration of a server; and

FIG. 4 is a flowchart showing a process executed by a vehicle control device.

### DETAILED DESCRIPTION OF EMBODIMENTS

An information processing device, a vehicle, and a storage medium according to an embodiment of the present disclosure will be described with reference to the drawings. Note that, constituent components in the following embodiment also include those that can be easily replaced by those skilled in the art, or those that are substantially identical.

### Embodiment

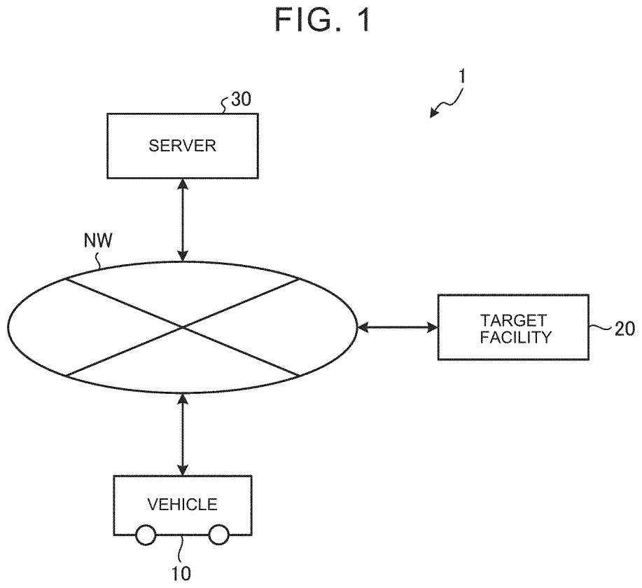

A power supply system including a vehicle according to the embodiment will be described with reference to FIGS. 1 to 3. FIG. 1 is a diagram schematically showing a configuration of the power supply system including an information processing device according to the embodiment. As shown in FIG. 1, a power supply system 1 includes a vehicle 10, a target facility 20, and a server 30. In the power supply system 1, for example, the server 30 assists power supply from the vehicle 10 to the target facility 20.

The vehicle 10, the target facility 20, and the server 30 are configured to be able to communicate with each other through a network NW. The network NW is, for example, a public communication network such as the Internet, and may include a wide area network (WAN), a telephone communication network, and other communication networks such as a wireless communication network including Wi-Fi (registered trademark).

Further, for example, communication between the vehicle 10 and the target facility 20 is not limited to being performed via the network NW, and the vehicle 10 and the target facility 20 may be able to communicate directly with each other without the network NW. With the above, even when the network NW cannot be used in the event of a disaster, electric power can be supplied from the vehicle 10 to the target facility 20.

The vehicle 10 is an autonomous traveling vehicle configured to be able to travel autonomously in accordance with at least a given traveling command. The vehicle 10 can supply a part of the electric power generated by driving an engine with fuel such as gasoline or hydrogen or a part of the electric power stored in a power supply device to the outside. Specifically, the vehicle 10 is a gasoline-powered vehicle, a hybrid electric vehicle (HEV), a plug-in hybrid electric vehicle (PHEV), a fuel cell electric vehicle (FCEV), or the like that are capable of supplying electric power.

The target facility 20 is a facility, such as a house, to which the vehicle 10 supplies electric power. A plurality of electronic devices including security devices such as security cameras and various types of home appliances such as refrigerators and rice cookers are electrically connected to the electric lines of the target facility 20.

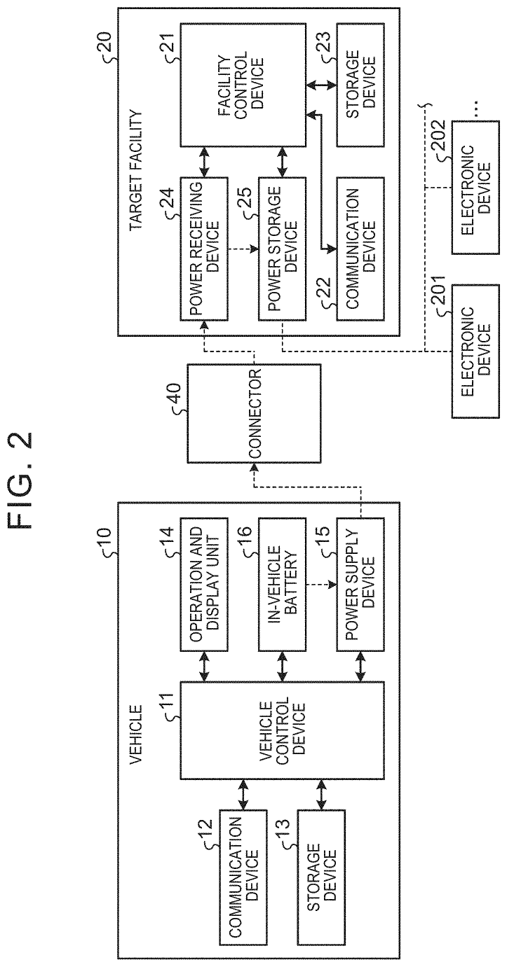

FIG. 2 is a diagram schematically showing a state in which the vehicle 10 and the target facility 20 are connected by a connector. The vehicle 10 includes a vehicle control device 11 as an information processing device, a communication device 12, a storage device 13, an operation and display unit 14, a power supply device 15, and an in-vehicle battery 16.

The vehicle control device 11 is provided with a processor including a central processing unit (CPU), a digital signal processor (DSP), a field-programmable gate array (FPGA), etc., and a memory including a random access memory (RAM), a read-only memory (ROM), etc. The vehicle control device 11 loads a program stored in the storage device 13 into the work area of the memory and executes the program, and controls each component, etc. through the execution of the program such that the function that satisfies a predetermined purpose can be realized.

When the vehicle control device 11 acquires power supply request information requesting supply of electric power to the target facility 20, the vehicle control device 11 selects an electronic device to which electric power is supplied from among electronic devices 201, 202, . . . based on the power supply request information. The power supply request information includes, for example, a priority of power supply set by a user in advance for each electronic device. The priority is, for example, a numerical value indicating the degree of priority of power supply, and as the numerical value of an electric appliance becomes larger, electric power is supplied to the electric appliance more preferentially. The priority is set in advance by the user and stored in the storage device 23. Then, the vehicle control device 11 acquires the priority from the storage device 23, and selects the electronic device of which priority is equal to or higher than a threshold value. Further, the vehicle control device 11 controls the power reception from the target facility 20 and the power supply to the target facility 20. For example, when the vehicle control device 11 acquires power failure information indicating that the power supply to the target facility 20 is stopped, the vehicle control device 11 may cause the vehicle power supply device 15 to start power supply to the target facility 20. The power failure information is output from the facility control device 21 that detects the power failure to the vehicle control device 11. With the above, it is possible to maintain the functions of electronic devices, such as a security camera that is highly important in terms of security in the event of a power failure.

The communication device 12 is composed of, for example, a local area network (LAN) interface board, a wireless communication circuit for wireless communication, and the like. The communication device 12 is connected to the network NW such as the Internet that is a public communication network. The communication device 12 communicates with the target facility 20 and the server 30 by connecting to the network NW.

The storage device 13 is configured of a recording medium (storage medium) such as an erasable programmable ROM (EPROM), a hard disk drive (HDD), and a removable medium. Examples of the removable medium include recording media such as an optical disc (e.g. compact disc (CD)-R or CD-ROM, digital versatile disc (DVD)-R or DVD-ROM, Blu-ray (registered trademark) disc) and a flash memory (e.g. a universal serial bus (USB) memory, a memory card). The storage device 13 can store an operating system (OS), various programs, various tables, various databases, and the like.

The operation and display unit 14 is composed of, for example, a touch panel display, and has an input function for receiving an operation of the user with a finger, etc. and a display function for displaying various types of information based on the control of the vehicle control device 11. The operation and display unit 14 is, for example, a touch panel display of a car navigation system.

The power supply device 15 supplies electric power to the outside of the vehicle 10. The power supply device 15 is, for example, an inlet to which the connection portion of a connector 40 is connected, and electric power is supplied to a power receiving device 24 via the connector 40 in a contact manner. Further, the power supply device 15 may bring the power transmission coil and the power receiving coil close to each other and supply electric power to the power receiving device 24 in a non-contact manner via the power transmitting coil and the power receiving coil.

The in-vehicle battery 16 can receive electric power from the target facility 20 and store the electric power, and can supply electric power to the target facility 20. Further, the in-vehicle battery 16 is composed of, for example, a secondary battery such as a nickel-metal hydride battery or a lithium-ion battery, and supplies electric power to a drive device of the vehicle 10 including a motor or an inverter. Further, the in-vehicle battery 16 may be configured to be rechargeable with power of the driven engine. When the vehicle 10 is a gasoline-powered vehicle, the vehicle 10 may be configured not to include the in-vehicle battery 16.

The target facility 20 includes a facility control device 21, a communication device 22, a storage device 23, the power receiving device 24, and a power storage device 25. The physical configurations of the facility control device 21, the communication device 22, and the storage device 23 are the same as, for example, the configurations of the vehicle control device 11, the communication device 12, and the storage device 13 included in the vehicle 10, respectively. Further, a plurality of the electronic devices 201, 202, . . . is electrically connected to the target facility 20.

The power receiving device 24 receives the electric power from the power supply device 15 via the connector 40. The power receiving device 24 includes a connection portion such as an outlet to which the connector 40 is connected. When the target facility 20 does not include the power storage device 25, the power receiving device 24 may directly supply electric power to the electronic devices 201, 202, . . . .

The power storage device 25 is composed of, for example, a secondary battery such as a nickel hydrogen battery or a lithium ion battery, and stores electric power that is used in the target facility 20. The power storage device 25 supplies electric power to the electronic devices 201, 202, . . . .

The electronic device 201 includes a security device such as a security camera and various types of home appliances such as a refrigerator and a rice cooker, and is electrically connected to the target facility 20. Similarly, the other electronic devices 202, . . . are security devices and various types of home appliances, and are electrically connected to the target facility 20.

The connector 40 connects the power supply device 15 of the vehicle 10 and the power receiving device 24 of the target facility 20. The connector 40 includes a connection portion connected to the inlet of the power supply device 15 and an outlet insertion slot to which an outlet of the power receiving device 24 is connected.

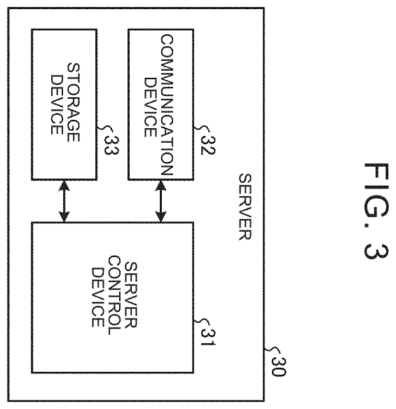

FIG. 3 is a diagram showing a schematic configuration of a server. A server 30 includes a server control device 31, a communication device 32, and a storage device 33. The physical configurations of the server control device 31, the communication device 32, and the storage device 33 are the same as, for example, the configurations of the vehicle control device 11, the communication device 12, and the storage device 13 included in the vehicle 10, respectively.

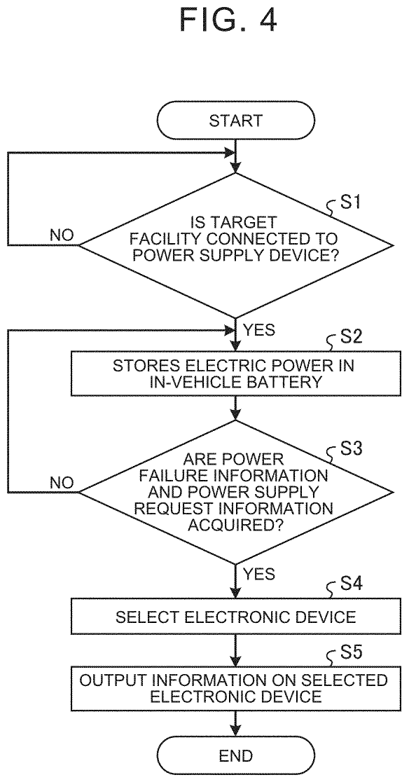

Next, a process executed by the vehicle control device 11 will be described. FIG. 4 is a flowchart showing a process executed by the vehicle control device 11. The storage device 23 stores the priority of power supply to the electronic devices 201, 202, . . . set in advance by the user as the power supply request information. The user sets a high priority for the security device such as a security camera that is preferably supplied with electric power on a constant basis from the viewpoint of maintaining security in the event of a power failure due to a disaster or the like. Further, the user sets a high priority for the home appliance such as a refrigerator that is preferably supplied with electric power on a constant basis from the viewpoint of maintaining convenience in daily life in the event of a power failure due to a disaster or the like.

First, the vehicle control device 11 determines whether the power supply device 15 is connected to the target facility 20 via the connector 40 (step S1). Specifically, the vehicle control device 11 determines whether a signal indicating that the target facility 20 is electrically connected to the power supply device 15 is detected. When the vehicle control device 11 determines that the target facility 20 is not connected to the power supply device 15 (step S1: No), the vehicle control device 11 repeats the process in step S1.

When the vehicle control device 11 determines that the target facility 20 is connected to the power supply device 15 (step S1: Yes), the vehicle control device 11 starts power storage in the in-vehicle battery 16 from the target facility 20 (step S2).

After that, the vehicle control device 11 determines whether the power failure information and the power supply request information are acquired (step S3). When the facility control device 21 detects that the power supply to the target facility 20 is stopped, the facility control device 21 outputs the power failure information and the power supply request information to the vehicle control device 11. When the vehicle control device 11 determines that the power failure information and the power supply request information are not acquired (step S3: No), the vehicle control device 11 repeats the process in step S2.

When the vehicle control device 11 determines that the power failure information and the power supply request information are acquired (step S3: Yes), the vehicle control device 11 selects the electronic device to which electric power is supplied from among the electronic devices 201, 202, . . . based on the power supply request information acquired from the facility control device 21 (step S4). Specifically, the vehicle control device 11 selects an electronic device of which priority is equal to or higher than the threshold value. For example, the vehicle control device 11 selects the security camera or the refrigerator having a high priority as the electronic device to which electric power is supplied.

After that, the vehicle control device 11 outputs information of the selected electronic device to the target facility 20 (step S5). Then, the facility control device 21 of the target facility 20 controls the power storage device 25 and supplies electric power to the electronic device selected from among the electronic devices 201, 202, . . . . For example, the facility control device 21 supplies electric power to the security camera or the refrigerator selected by the vehicle control device 11. Then, the vehicle control device 11 ends the series of processes.

According to the vehicle control device 11 according to the embodiment described above, the vehicle control device 11 selects the electronic device to which electric power is supplied from among the electronic devices 201, 202, . . . in accordance with the power supply request information. As a result, electric power can be supplied to the electronic devices 201, 202, . . . in an appropriate manner. Further, the vehicle control device 11 selects an electronic device of which priority is equal to or higher than the threshold value.

As a result, electric power can be supplied to the electronic device in accordance with the priority in an appropriate manner Specifically, in the event of a power failure occurring in the target facility 20 due to a disaster or the like, electric power can be supplied for a long time to the electronic devices such as a security camera of which importance is high for maintaining security or a refrigerator of which importance is high for maintaining convenience in daily life.

Further, the power supply request information may include selection information in which the electronic device to which electric power is supplied from the power supply device 15 is selected by the user through an input. Specifically, the vehicle control device 11 displays a selection screen for selecting the electronic device to which electric power is supplied on the operation and display unit 14 and acquires the selection information based on an operation input to the operation and display unit 14. At this time, the vehicle control device 11 may select the electronic device to which electric power is supplied from the power supply device 15 in accordance with the selection information. The vehicle control device 11 may display a selection screen for selecting an electronic device to which electric power is supplied on a terminal such as a smartphone carried by the user.

Further, the power supply request information may include characteristic information representing the characteristics of the electronic device. The facility control device 21 acquires the characteristic information of the electronic devices 201, 202, . . . by wired or wireless communication. The characteristic information is, for example, information indicating whether each electronic device constantly requires electric power. In this case, the vehicle control device 11 selects an electronic device of which characteristic information indicates that the electronic device constantly requires electric power. As a result, it is possible to supply electric power to the electronic device such as the security camera or the refrigerator that constantly requires electric power in the event of a power failure. Further, the characteristic information is information indicating whether the function of each electronic device is a function required at the time of a disaster, for example. In this case, the vehicle control device 11 selects an electronic device of which the characteristic information indicates that the electronic device has a function required in the event of a disaster. As a result, it is possible to supply electric power to the electronic device such as a security camera required for security in the event of a disaster or a refrigerator required for storing food in the event of a disaster.

When the vehicle 10 is a vehicle that can store electric power in the in-vehicle battery 16 by driving the engine, the vehicle control device 11 may notify the user of that the remaining capacity of the in-vehicle battery 16 is equal to or less than a threshold value due to the power supply to the target facility 20. The vehicle control device 11 can store electric power in the in-vehicle battery 16 or supply electric power to the target facility 20 by driving the engine to generate electric power for power supply in response to an instruction input by the user.

When the connector 40 includes a processor composed of a CPU and the like, and a memory composed of a RAM, a ROM, and the like, the connector 40 may have the function of the information processing device. Specifically, when the connector 40 acquires the power supply request information requesting supply of electric power to the target facility 20, the connector 40 may select the electronic device to which electric power is supplied from among the electronic devices 201, 202, . . . based on the power supply request information.

Further, the facility control device 21 or the server control device 31 may have the function of the information processing device. For example, when the facility control device 21 or the server control device 31 acquires the power supply request information requesting supply of electric power to the target facility 20 via the network NW or the like, the facility control device 21 or the server control device 31 may select the electronic device to which electric power is supplied from among the electronic devices 201, 202, . . . based on the power supply request information.

Further effects and modifications can be easily derived by those skilled in the art. The broader aspects of the present disclosure are not limited to the particular details and representative embodiments shown and described above. Accordingly, various modifications may be made without departing from the spirit or scope of the general concept of the disclosure defined by the appended claims and their equivalents.

What is claimed is:

1. An information processing device comprising a processor configured to select, when the processor acquires power supply request information requesting supply of electric power from a vehicle equipped with a power supply device that supplies electric power to outside to a power supply target to which a plurality of electronic devices is connected, the electronic device to which electric power is supplied from among the electronic devices based on the power supply request information.

2. The information processing device according to claim 1, wherein:
the power supply request information includes a priority of power supply set by a user in advance for each of the electronic devices; and
the processor selects the electronic device of which the priority is equal to or higher than a threshold value.

3. The information processing device according to claim 1, wherein:
the power supply request information includes selection information in which the electronic device to which electric power is supplied from the power supply device is selected by the user through an input; and
the processor selects the electronic device to which electric power is supplied from the power supply device based on the selection information.

4. The information processing device according to claim 1, wherein:
the power supply request information includes characteristic information representing a characteristic of the electronic device; and
the processor selects the electronic device of which the characteristic information indicates that the electronic device constantly requires electric power.

5. The information processing device according to claim 1, wherein:
the power supply request information includes characteristic information representing a characteristic of the electronic device; and
the processor selects the electronic device of which the characteristic information indicates that the electronic device is provided with a function required in an event of a disaster.

6. The information processing device according to claim 1, wherein:
the vehicle includes an in-vehicle battery that is able to receive electric power from the power supply target and store the received electric power, and is able to supply electric power to the power supply target; and
the processor controls power reception from the power supply target and power supply to the power supply target.

7. The information processing device according to claim 6, wherein when the processor acquires power failure information indicating that power supply to the power supply target is stopped, the processor starts power supply from the power supply device to the power supply target.

8. A vehicle comprising:
a power supply device that supplies electric power to outside; and
a processor configured to select, when the processor acquires power supply request information requesting supply of electric power to a power supply target to which a plurality of electronic devices is connected, the electronic device to which electric power is supplied from among the electronic devices based on the power supply request information.

9. The vehicle according to claim 8, wherein:
the power supply request information includes a priority of power supply set by a user in advance for each of the electronic devices; and
the processor selects the electronic device of which the priority is equal to or higher than a threshold value.

10. The vehicle according to claim 8, wherein:
the power supply request information includes selection information in which the electronic device to which electric power is supplied from the power supply device is selected by the user through an input; and
the processor selects the electronic device to which electric power is supplied from the power supply device based on the selection information.

11. The vehicle according to claim 8, wherein:
the power supply request information includes characteristic information representing a characteristic of the electronic device; and
the processor selects the electronic device of which the characteristic information indicates that the electronic device constantly requires electric power.

12. The vehicle according to claim 8, wherein:
the power supply request information includes characteristic information representing a characteristic of the electronic device; and
the processor selects the electronic device of which the characteristic information indicates that the electronic device is provided with a function required in an event of a disaster.

13. The vehicle according to claim 8, further comprising an in-vehicle battery that is able to receive electric power from the power supply target and store the received electric power, and is able to supply electric power to the power supply target, wherein the processor controls reception of electric power from the power supply target and power supply to the power supply target.

14. The vehicle according to claim 13, wherein when the processor acquires power failure information indicating that the power supply to the power supply target is stopped, the processor starts power supply from the power supply device to the power supply target.

15. A non-transitory storage medium storing a program that causes a processor to select, when power supply request information requesting supply of electric power from a vehicle equipped with a power supply device that supplies electric power to outside to a power supply target to which a plurality of electronic devices is connected is acquired, the electronic device to which electric power is supplied from among the electronic devices based on the power supply request information.

16. The storage medium according to claim 15, wherein:
the power supply request information includes a priority of power supply set by a user in advance for each of the electronic devices; and
the processor is caused to select the electronic device of which the priority is equal to or higher than a threshold value.

17. The storage medium according to claim 15, wherein:
the power supply request information includes selection information in which the electronic device to which electric power is supplied from the power supply device is selected by the user through an input; and
the processor is caused to select the electronic device to which electric power is supplied from the power supply device based on the selection information.

18. The storage medium according to claim 15, wherein:
the power supply request information includes characteristic information representing a characteristic of the electronic device; and
the processor is caused to select the electronic device of which the characteristic information indicates that the electronic device constantly requires electric power.

19. The storage medium according to claim 15, wherein:
the power supply request information includes characteristic information representing a characteristic of the electronic device; and
the processor is caused to select the electronic device of which the characteristic information indicates that the electronic device is provided with a function required in an event of a disaster.

20. The storage medium according to claim 15, wherein:
the vehicle includes an in-vehicle battery that is able to receive electric power from the power supply target and store the received electric power, and is able to supply electric power to the power supply target; and
the processor is caused to control reception of electric power from the power supply target and power supply to the power supply target.
